(19) United States
(12) Patent Application Publication
(10) Pub. No.: US 2009/0284444 A1
(43) Pub. Date: Nov. 19, 2009

(54) Removable optical filter and retainer

(76) Inventors: Jeffrey Allen Wilson, Wetumpka, AL (US); T. Craig Ingram, Prattville, AL (US); James M. Beam, Montgomery, AL (US); Rory J. Jones, Meridianville, AL (US)

Correspondence Address: MEREK, BLACKMON & VOORHEES, LLC, 673 S. WASHINGTON ST, ALEXANDRIA, VA, 22314, US

(21) Appl. No.: 12/216,855

(22) Filed: Jul. 11, 2008

Related U.S. Application Data
(60) Provisional application No. 61/071,774, filed on May 16, 2008.

(51) Int. Cl. G09G 3/00

(52) U.S. Cl. 345/32

(57) ABSTRACT

An apparatus for releasably retaining an optical filter on a display screen includes an anchoring arrangement on a housing of the display screen and a latch mechanism positioned on the housing, wherein the latch mechanism is spaced from the anchoring arrangement, movable relative to the anchoring arrangement, resiliently biased toward the anchoring arrangement, and able to clamp the optical filter against the anchoring arrangement.

### FIELD OF THE INVENTION

The present invention relates to a removable optical filter for display screens, especially for touch screen displays.

### BACKGROUND OF THE INVENTION

Display screens are common in electronic devices, such as laptop computers, and touch screen displays are known for use in connection with computers, including laptop computers. Furthermore, use of optical filters, including night vision filters, with display screens is known.

Presently known optical filters for display screens include an adhesive-backed non-removable filter and an optical coating integrated with the display screen by the display manufacturer. Presently known optical filters, even those that are not permanently fixed, are not designed for quick removal. Furthermore, presently known optical filters do not permit functional use of a touch screen.

U.S. Pat. No. 5,909,315 to Keehn discloses a filter that is removably attached to a laptop, but its attachment arrangement is not adequately secure. In addition, although U.S. Pat. No. 6,469,752 to Ishikawa et al. discloses in FIG. 4 an arrangement in which an upper end of a protector screen is inserted first into a bracket portion 31 and then the lower end is pivoted into place, that arrangement is not suited for devices like, for example, laptop computers, and the protector screen is not easily removed or reinstalled.

### SUMMARY OF THE INVENTION

By the present invention, an optical filter is removable from a housing of a display screen, the optical filter being held in place by a filter retention arrangement that includes a sliding, positive-retention latch mechanism. The latch mechanism requires no tools and is operable with one hand, thereby eliminating the need for accessories or tools for operation. The optical filter includes a sheet of optical filter material clamped between two parts of a frame, the clamping area being adjacent to an inactive area of a touch screen, where the optical filter is used with a touch screen. Moreover, a small gap is maintained between the optical filter and the display screen, so that the optical filter of the present invention avoids interference with the operation of touch screens of types that require contact with the screen, such as a resistive type. In addition, the optical filter of the present invention is durable enough for repeated use.

Neither the optical filter nor the latch mechanism of the present invention requires electrical power, thereby making implementation of the optical filter and the latch mechanism possible on a greater array of existing devices without redesign of internal components of the existing devices. In addition, the optical filter and latch mechanism are designed not to interfere with the opening and closing of the products with which they are used, such as laptop computers. Furthermore, where the products are required to pass qualification tests, such as those associated with government contracts, the optical filter and latch mechanism according to the present invention do not affect existing qualification test results. Therefore, the optical filter and latch mechanism according to the present invention can be implemented on existing products, thereby avoiding the need to purchase, for example, new computers and pass further qualification tests in order that the benefits of the optical filter and latch mechanism of the present invention can be obtained.

The sliding, positive retention latch mechanism of the filter retention arrangement contacts the frame of the optical filter in a plurality of spaced apart contact areas, for example, three spaced apart contact areas, while applying force to the frame in two directions—toward the display screen housing and toward an anchoring arrangement that is an upper portion of the filter retention arrangement. This contact ensures full compression of a gasket between the frame and the housing, or bezel, of the display screen to greatly reduce the risk of “light leaks” between the frame and the housing. The sliding, positive retention latch mechanism engages, and disengages, the frame of the optical filter in all of the spaced areas at the same time, thereby reducing the time and effort of mounting the optical filter on the display screen and dismounting the optical filter from the display screen.

The upper portion of the filter retention arrangement comprises at least one anchoring element, preferably a plurality of spaced anchoring elements, such as bolts or screws, secured to the display screen housing above the display screen, the anchoring elements each having a head or other overhang. In addition, an upper edge of the frame has notched formations, in a number corresponding to the number of anchoring elements, that fit against the anchoring elements and under and against the overhang.

The latch mechanism is spring biased toward the anchoring elements, the latch mechanism having spaced apart contact elements that engage corresponding spaced-apart contact elements on the frame of the optical filter to define the contact areas. It is preferred that the contact elements of the latch mechanism be beveled, and that the contact elements of the frame of the optical filter be beveled to complement the beveled contact elements of the latch mechanism. As a result of this arrangement, the frame is urged into engagement with the anchoring elements and also cammed against the housing, or bezel, of the display screen, with a gasket interposed, whereby the risk of “light leaks” between the optical filter and the display screen, around the peripheries of the optical filter and the display screen, is greatly reduced.

When it is desired to remove the optical filter, the latch mechanism is slid downward against the force of the springs to free the filter from the latch mechanism; the lower edge of the frame is lifted away from the housing of the display screen, for example, the display screen of a laptop computer; and the optical filter is slid down and away from engagement with the anchoring elements. All of the spaced contact elements of the latch mechanism engage and disengage the spaced contact elements of the optical filter at the same time as one another, thereby reducing the mounting and dismounting time and effort.

In addition, at least where the optical filter according to the present invention is used with a touch screen of a type that requires contact with the screen, such as a resistive type, the filter material of the optical filter, which can be a translucent polymer material, is flexible enough to be deformed by a finger into point contact with the underlying screen. The filter material can have color enhancements to filter the light for night vision.

### BRIEF DESCRIPTION OF THE DRAWINGS

FIG. 1 is a perspective view, taken from the top, front and right side, of an optical filter and a filter retention arrangement in place on a ruggedized laptop computer;

FIG. 2 is an enlarged front elevation of the optical filter and a filter retention arrangement of FIG. 1 in place on the upper component of the ruggedized laptop computer;

FIG. 3 is an enlarged front elevation of the a filter retention arrangement and upper component of the ruggedized laptop computer of FIG. 2, with the optical filter removed;

FIG. 4 is a perspective view, taken from the top, front and right side, of a fragment of the optical filter of FIG. 2 in engagement with an upper portion of the filter retention arrangement without the upper component of the ruggedized laptop computer;

FIG. 5 is an exploded perspective view taken from the bottom, rear and left side of a lower portion of the filter retention arrangement of FIG. 2;

FIG. 6 is a front elevation of the optical filter of FIG. 2;

FIG. 7 is a cross section taken along the line 7-7 of FIG. 6;

FIG. 8 is an enlarged view of the portion of FIG. 7 encircled by the line 8-8; and

FIG. 9 is a view of the portion of FIG. 8 in engagement with the right side of the upper component of the ruggedized laptop computer of FIG. 2.

### DETAILED DESCRIPTION OF THE PREFERRED EMBODIMENTS

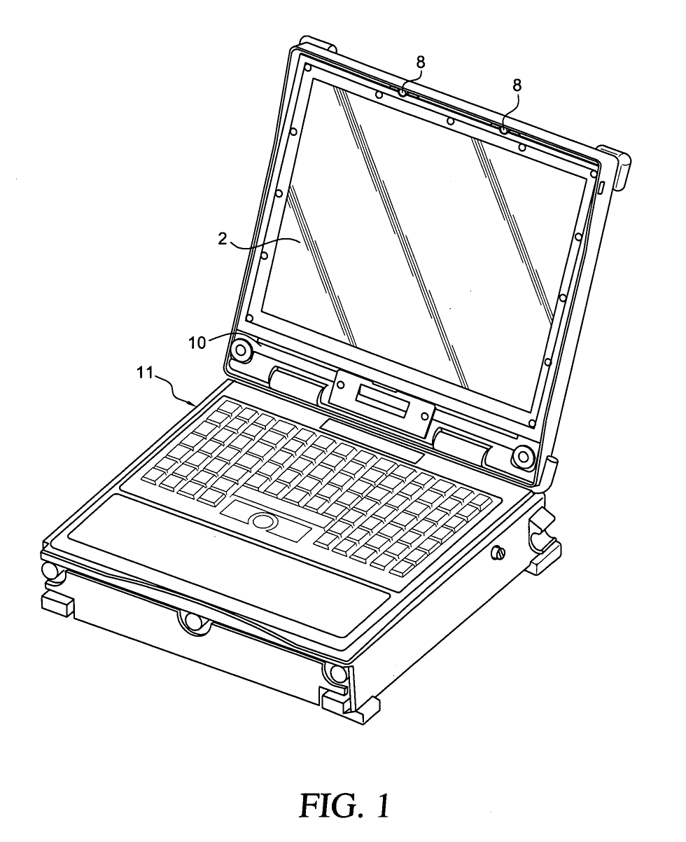

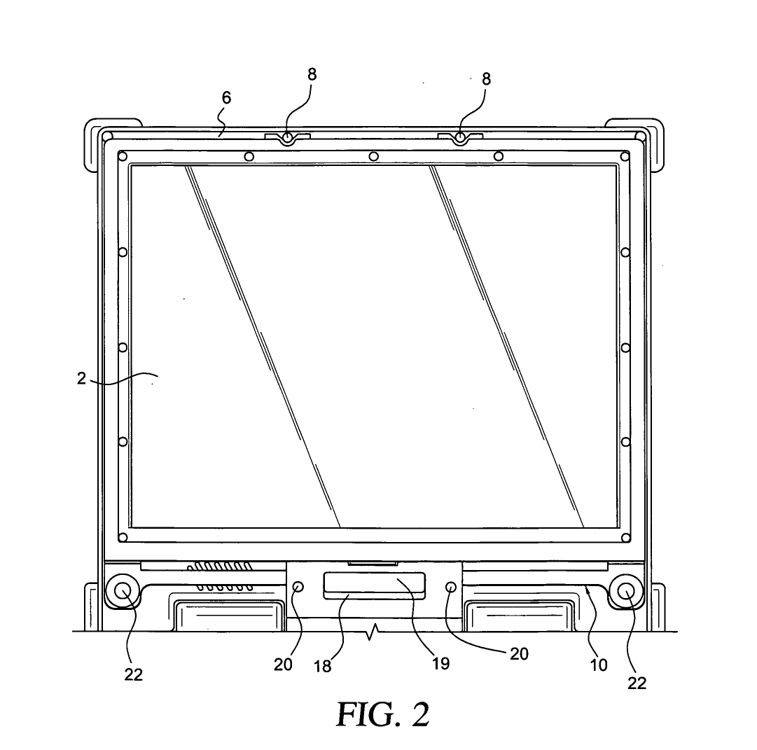

As can be seen from FIGS. 1-4, an apparatus according to the present invention for retaining an optical filter 2 on a display screen 4 having a housing 6 includes an anchoring arrangement 8 and a latch mechanism 10, both positioned on the housing. The latch mechanism 10 is spaced from the anchoring arrangement 8, is movable relative to the anchoring arrangement, is resiliently biased toward the anchoring arrangement, and is adapted to clamp the optical filter 2 against the anchoring arrangement. In the illustrated embodiment, the housing 6 is part of a laptop computer 11 having an upper component hinged to a lower component. It can be seen that the optical filter 2, the anchoring arrangement 8 and the latch mechanism 10 are all within the perimeter of the upper component of the laptop. In addition, the optical filter 2, the anchoring arrangement 8 and the latch mechanism 10 all fit within a space that exists between the upper and lower components when the laptop is closed. The optical filter 2, the anchoring arrangement 8 and the latch mechanism 10 do not interfere with the opening and closing of the laptop.

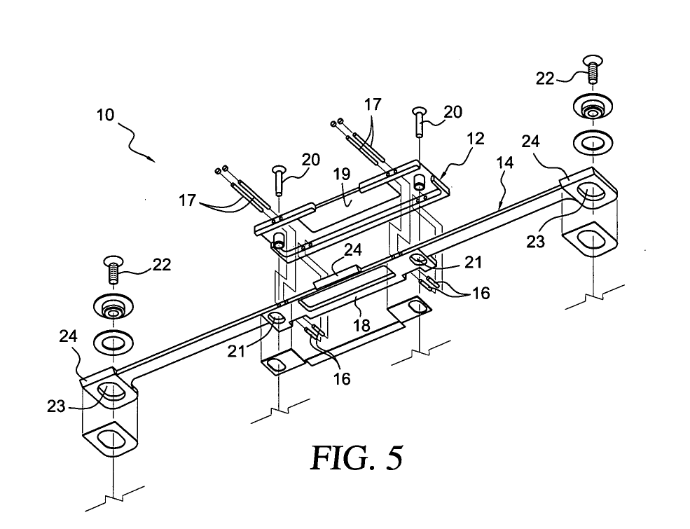

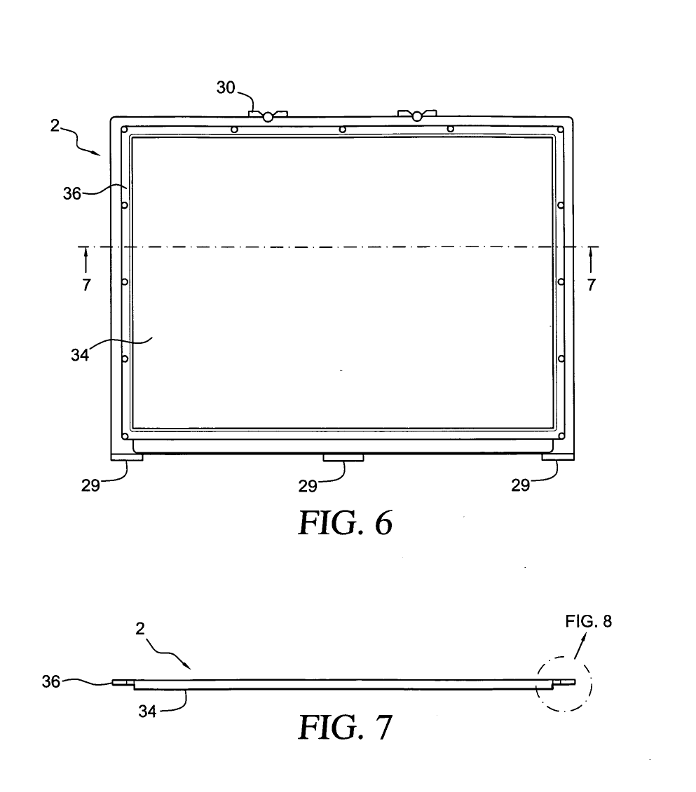

As can be seen from FIG. 5, the latch mechanism 10 has a first portion 12 fixed to the housing 6, a second portion 14 movable relative to the first portion in a direction toward and away from the anchoring arrangement 8, and a resilient biasing arrangement 16, such as one or more springs, biasing the second portion to move relative to the first portion. More specifically, the second portion 14 is slidably mounted on a plurality of rods 17 held in a recess on the underside of the first portion 12. The springs of the resilient biasing arrangement 16 are mounted around the rods 17, between the movable portion 14 and a front surface in the recess on the underside of the first portion 12. The second portion 14 has a hand-accessible manipulation portion 18 enabling the second portion to be moved relative to the first portion in a direction away from the anchoring arrangement 8 against the bias of the resilient biasing device 16. The first portion 12 includes an opening 19 that enables the hand-accessible manipulation portion 18 to be accessed to move the second portion 14.

Fasteners 20, such as screws, secure the first portion 12 of the latch mechanism 10 to the housing 6 through elongated openings 21 in the second portion 14 that enable the second portion to move relative to the first portion. Additional fasteners 22, such as screws, are secured to the housing 6 through elongated openings 23 at lateral ends of the second portion 14 to guide the ends during movement of the second portion.

The latch mechanism 10 has at least one contact portion having a bevel surface 24 adapted to cam the optical filter 2 toward the housing 6. In the illustrated embodiment, the latch mechanism 10 has a plurality of contact portions spaced from one another, each contact portion having a bevel surface 24 adapted to cam the optical filter 2 toward the housing 6. In the illustrated embodiment, contact portions with bevel surfaces 24 are positioned at the center of the movable portion 14 (adjacent to the hand-accessible manipulation portion 18) and at the lateral ends of the movable portion, in alignment with the elongated openings 23. The bevel surfaces 24 are arranged to engage the optical filter 2 simultaneously with one another and disengage from the optical filter simultaneously with one another upon movement of the latch mechanism 10 relative to the anchoring arrangement 8.

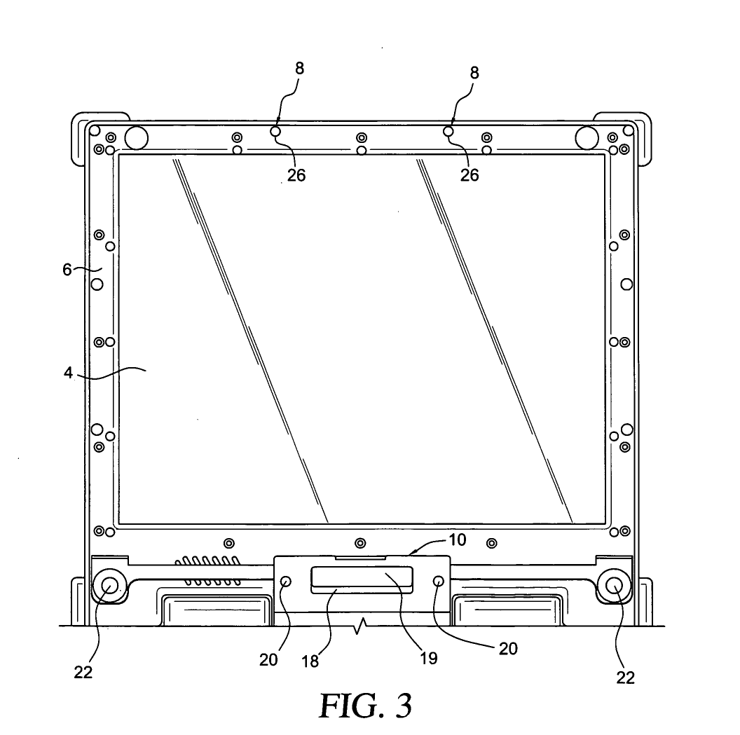

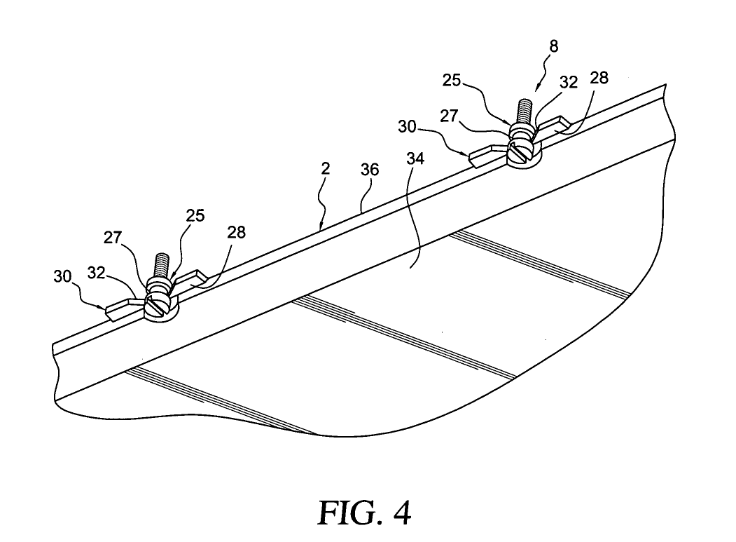

The anchoring arrangement 8 includes at least one anchoring element 25 that has a head or overhang, such as a bolt or a screw, secured to the housing 6 above the display screen 4. The anchoring element 25 has a first surface 26 (FIG. 3) facing the latch mechanism 10 and a second surface 27 (FIG. 4) facing the housing 6, the second surface being spaced from the housing sufficiently to accommodate the optical filter 2. As can be seen from FIG. 4, the anchoring element 25 is positioned to extend over a surface 28 of the optical filter 2 that faces away from the housing 6. In the illustrated embodiment, the anchoring arrangement 8 includes a plurality of anchoring elements 25, each having a first surface 26 (FIG. 3) facing the latch mechanism 10 and a second surface 27 facing the housing 6, the second surface being spaced from the housing sufficiently to accommodate the optical filter 2. Each anchoring element 25 is positioned to extend over a surface 28 of the optical filter 2 facing away from the housing 6, the second surfaces 27 of the anchoring elements 25 contacting the surfaces 28 of the optical filter 2 facing away from the housing 6.

Preferably, the optical filter 2 has at least one contact area having a bevel surface 29 engaging the bevel surface 24 of the latch mechanism 10, the bevel surface 29 being at an angle that is complementary to the angle of the bevel surface 24. In the illustrated embodiment, the optical filter 2 has a plurality of contact areas having bevel surfaces 29 spaced from one another, each of the bevel surfaces engaging a respective one of the bevel surfaces 24 of the latch mechanism 10. At least one tab 30 protrudes from the optical filter 2 toward the anchoring arrangement 8, the tab having a recess 32 in which the anchoring arrangement is received. The surface 28 of the optical filter 2 facing away from the housing 6 is on the tab 30. In the illustrated embodiment, a plurality of tabs 30 protrude from the optical filter 2 toward the anchoring arrangement 8, each of the tabs having a recess 32, or notch, in which a respective one of the anchoring elements 25 is received and a surface 28, facing away from the housing 6, that is contacted by a respective one of the anchoring elements 25. Although the recesses 32 are in the tabs 30 in the illustrated embodiment, the recesses can be formed instead along an upper edge of the main portion of the frame 36, wherein the number of recesses corresponds to the number of anchoring elements 25.

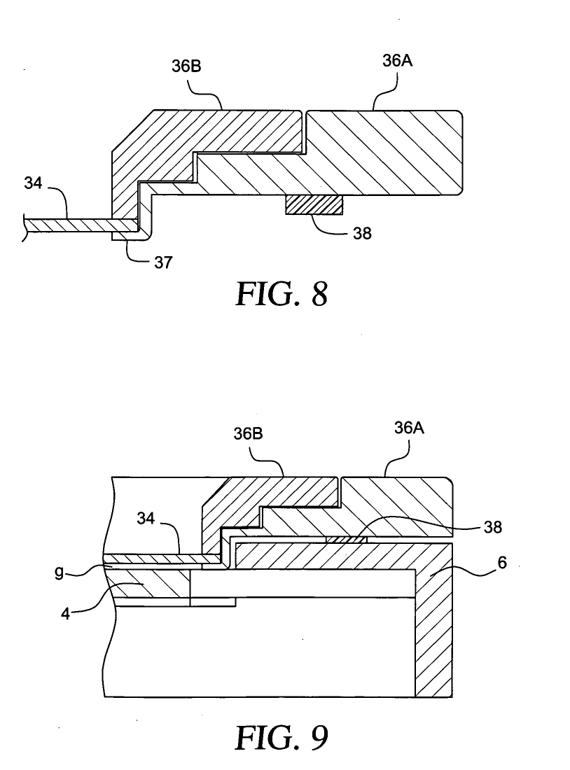

The optical filter material 34, for example, a translucent polymer material, such as polycarbonate or polyethylene, is sufficiently flexible to enable the display screen 4 to be contacted by the optical filter material when the optical filter is depressed, such as by the pressure of a finger of an operator. As can be appreciated from FIGS. 8 and 9, the frame 36 has a surface 37 facing in the same direction that the optical filter material 34 faces, the frame extending beyond the optical filter material, on all sides of the optical filter material, in the direction in which the optical filter material faces, so that a gap ‘g’ is maintained between the optical filter 2 and the display screen 4. The optical filter material 34 has an area larger than a display screen 4 with which the optical filter 2 is to be used, whereby, where the display screen is a touch screen, the gap ‘g’ between the optical filter 2 and the display screen extends across the entire surface of the display screen, and the display screen can be contacted by the optical filter material when the optical filter is depressed. The optical filter material 34 can have color enhancements to filter the light for night vision.

As can be appreciated from FIG. 9, a display apparatus according to the present invention includes a display screen 4, a housing 6, such as the housing of a computer, containing the display screen while exposing the display screen to view, an optical filter 2, an anchoring arrangement 8 positioned on the housing, and a latch mechanism 10 positioned on the housing. The display apparatus is especially beneficial where the display screen 4 is a touch screen, because a gap is maintained between the optical filter 2 and the display screen across the entire surface of the display screen, and the optical filter includes an optical filter material 34 that is sufficiently flexible to be deformed by a finger into point contact with the underlying display screen.

As can be seen from FIGS. 8 and 9, the optical filter material 34 is clamped between two parts 36A and 36B of the frame 36 that are made, preferably, of stainless steel. Where the optical filter 4 is used with a touch screen, the frame 36 contacts an inactive area of the touch screen, and the filter material 34 is spaced slightly from the touch screen by the gap ‘g’, thereby allowing functional use of the touch screen. A compressible gasket 38 is positioned between the frame 36 and the housing 6, or bezel, of the laptop to prevent light leaks.

The latch mechanism 10 is a sliding, positive retention latch mechanism that contacts the frame 36 of the optical filter 2 in a plurality of spaced apart contact areas, for example, three spaced apart contact areas, while applying force to the frame in two directions—toward the display screen housing 6 and toward the anchoring arrangement 8. This contact ensures full compression of the gasket 38 to greatly reduce the risk of “light leaks” between the frame 36 and the housing 6. The latch mechanism 10 engages, and disengages, the frame 36 of the optical filter 2 in all three spaced areas at the same time, thereby reducing the time and effort of mounting the optical filter on the display screen and dismounting the optical filter from the display screen.

In operation, when it is desired to remove the optical filter 2, the latch mechanism 10 is slid downward against the force of the springs of the resilient biasing device 16 to free the latch mechanism from the optical filter, the lower edge of the frame 36 is lifted away from the housing 6 of the display screen 4, for example, the display screen of a laptop computer, and the optical filter is slid down and away from engagement with the anchoring elements 25. All of the spaced contact elements of the latch mechanism 10 engage and disengage the spaced contact elements of the optical filter 2 at the same time as one another, thereby reducing the mounting and dismounting time and effort.

It will further be appreciated by those skilled in the art and it is contemplated that variations to the embodiments illustrated and described herein may be made without departing from the spirit and scope of the present invention. Accordingly, it is intended that the foregoing description is illustrative only, and the true spirit and scope of the invention will be determined by the appended claims.

1. Apparatus for retaining an optical filter on a display screen having a housing, comprising:
an anchoring arrangement positioned on the housing; and
a latch mechanism positioned on the housing, wherein said latch mechanism is spaced from said anchoring arrangement, said latch mechanism is movable relative to said anchoring arrangement, said latch mechanism is resiliently biased toward said anchoring arrangement, and said latch mechanism is adapted to clamp the optical filter against said anchoring arrangement.

2. The apparatus of claim 1, wherein said latch mechanism has a first portion fixed to the housing, a second portion movable relative to the first portion toward and away from the anchoring arrangement, and a resilient biasing device biasing the second portion to move relative to the first portion.

3. The apparatus of claim 2, wherein said second portion has a hand-accessible manipulation portion enabling said second portion to be accessed to move said second portion relative to the first portion in a direction away from the anchoring arrangement against the bias of the resilient biasing device.

4. The apparatus of claim 1, wherein said latch mechanism has at least one bevel surface adapted to cam the optical filter toward the housing.

5. The apparatus of claim 4, wherein said latch mechanism has a plurality of bevel surfaces spaced from one another, each of said bevel surfaces being adapted to cam the optical filter toward the housing.

6. The apparatus of claim 5, wherein said bevel surfaces are arranged to engage the optical filter simultaneously with one another and disengage from the optical filter simultaneously with one another upon movement of the latch mechanism relative to the anchoring arrangement.

7. The apparatus of claim 1, wherein the anchoring arrangement comprises a first surface facing the latch mechanism and a second surface facing the housing, said second surface being spaced from said housing sufficiently to accommodate the optical filter and positioned to extend over a surface of the optical filter facing away from the housing.

8. The apparatus of claim 7, wherein the anchoring arrangement comprises a plurality of anchoring elements, each of said anchoring elements having a first surface facing the latch mechanism and a second surface facing the housing, each said second surface being spaced from said housing sufficiently to accommodate the optical filter and positioned to extend over a surface of the optical filter facing away from the housing.

9. In combination, an optical filter and apparatus for retaining the optical filter on a display screen having a housing, wherein the apparatus comprises:
an anchoring arrangement positioned on the housing; and
a latch mechanism positioned on the housing,
wherein said latch mechanism is spaced from said anchoring arrangement, said latch mechanism is resiliently biased toward said anchoring arrangement, and said latch mechanism is adapted to clamp the optical filter against said anchoring arrangement.

10. The combination of claim 9, wherein said latch mechanism has a first portion fixed to the housing, a second portion movable relative to the first portion toward and away from the anchoring arrangement, and a resilient biasing device biasing the second portion to move relative to the first portion.

11. The combination of claim 10, wherein said second portion has a hand-accessible manipulation portion enabling said second portion to be accessed to move said second portion relative to the first portion in a direction away from the anchoring arrangement against the bias of the resilient biasing device.

12. The combination of claim 9, wherein said latch mechanism has at least one bevel surface engaging the optical filter to cam the optical filter toward the housing.

13. The combination of claim 12, wherein the optical filter has at least one bevel surface engaging said at least one bevel surface of said latch mechanism.

14. The combination of claim 9, wherein said latch mechanism has a plurality of bevel surfaces spaced from one another, each of said bevel surfaces engaging the optical filter to cam the optical filter toward the housing.

15. The combination of claim 14, wherein the optical filter has a plurality of bevel surfaces spaced from one another, each of said bevel surfaces engaging a respective one of said bevel surfaces of said latch mechanism.

16. The combination of claim 14, wherein said bevel surfaces are arranged to engage the optical filter simultaneously with one another and disengage from the optical filter simultaneously with one another upon movement of the latch mechanism relative to the anchoring arrangement.

17. The combination of claim 9, wherein the anchoring arrangement comprises a first surface facing the latch mechanism and a second surface facing the housing, spaced from said housing sufficiently to accommodate the optical filter, and contacting a surface of the optical filter facing away from the housing.

18. The combination of claim 17, wherein a tab protrudes from the optical filter toward the anchoring arrangement, the tab has a recess in which said anchoring arrangement is received, and said surface of the optical filter facing away from the housing is on said tab.

19. The combination of claim 9, wherein the anchoring arrangement comprises a plurality of anchoring elements, each of said anchoring elements having a first surface facing the latch mechanism and a second surface facing the housing, spaced from said housing sufficiently to accommodate the optical filter, and contacting a surface of the optical filter facing away from the housing.

20. The combination of claim 19, wherein a plurality of tabs protrude from the optical filter toward the anchoring arrangement, each of said tabs has a recess in which a respective one of said anchoring elements is received, and each of said tabs has a surface, facing away from the housing, that is contacted by a respective one of said anchoring elements.

21. The combination of claim 9, wherein the optical filter includes an optical filter material and a frame, wherein the optical filter material is sufficiently flexible to enable the display screen to be contacted by the optical filter material when the optical filter material is depressed, wherein the optical filter material has a surface facing the display screen, wherein the frame has a surface facing in the direction that said surface of the optical filter material faces and extending beyond the optical filter material, on all sides of the optical filter material, in the direction in which said surface of the optical filter material faces, and wherein the optical filter material has an area larger than a display screen with which the combination is to be used, whereby, in the case of the display screen being a touch screen, a gap is maintained between the optical filter and the display screen across the entire surface of the display screen, and the display screen can be contacted by the optical filter material being depressed.
